(19) United States
(12) Patent Application Publication
(10) Pub. No.: US 2012/0047228 A1
(43) Pub. Date: Feb. 23, 2012

(54) METHOD FOR DELIVERING TAG BASED SERVICES

(76) Inventor: Shady Hassan Sayed Hassan Aly, Giza (EG)

(21) Appl. No.: 13/266,949

(22) PCT Filed: May 7, 2009
(86) PCT No.: PCT/EG2009/000015

§ 371 Date: Oct. 28, 2011

(51) Int. Cl. G06F 15/16; G06F 17/00

(52) U.S. Cl. 709/217; 235/375

(57) ABSTRACT

A service providing platform (100) utilizes machine readable tags or codes and makes available for use multiple services that can be reached in the context of these tags, i.e. tag based services. These services may or may not necessarily be platform dependent, i.e. dependent on the combination of hardware and/or software components that are used to read the tag and interface with the user. The list of services can be changed by an entity other than the tag issuer. Users can provide hints to the platform (100) along with the machine readable tags to influence the scope of the services provided by the platform.

### TECHNICAL FIELD

This invention relates generally to techniques for providing information and services through machine readable tags like barcode and RFID. More particularly it relates to methods for accessing tag based services through portable devices like mobile phones.

### BACKGROUND ART

Tagging technologies like Barcode and RFID have been around for some time and became an essential part of our daily life; almost every product in most supermarkets is tagged. This is mainly because tagging is an easy and cheap process, and it provides a great value. There are many applications that have been developed to allow end users to get a service by scanning a tag, like retrieving information about a certain product by scanning its barcode with a camera phone. Actually there are many services that could be reached by scanning a tag of a certain product using a portable device like a mobile phone. Examples of these services may include:
A service that directs the user to the website of the manufacturer, for more information about the product.
A service that will look up product information on online retailers, or search for locations where this product might be sold.
A service that will look up similar products with competitive prices, and give the user hints before the purchase.
After-sales services, like reporting a defective product, and contacting customer support.

Tag based services do not only apply for tags that are associated with products. Tag based services are services that could be accessed through machine readable tags, whether these tags are tagging a physical object, a location or anything. To further illustrate the point, in the context of a museum, tags could be used to tag items on display in the museum. Other tags could be placed in fixed locations in the museum like at the entrance of important locations to identify these locations. An application could be developed that displays a map of the museum. When a visitor scans a location tag, this tag could be used to highlight the location of the visitor on the map. The location tag could also be used to inform the user with nearby items, or provide other services like a virtual tour guide for museum visitors. There are many services that could be reached in the context of any of the location tags, not all services have to be created by someone associated with the museum administration. A school for example could create an application that displays a question to students when they scan any of the tags of the museum. The answer to this question is an item on display in the museum. When the student goes to this item and scans its tag, the student will get presented with more information about that item, and then get presented with another question. To answer it, the student will have to go to another item. And so on until the students learn about all the items they study in this school in an interactive treasure hunt method.

It is possible and likely that the all tag based services that use a certain tag are not to be developed by the same entity. For a product tag, the after-sales service is probably created by an entity affiliated with the product manufacturer, while a service that provides information about competitive products is probably not. To access any of these services, an application should be installed on the mobile phone that is able to scan the tag, and respond in a way that is specific to the service (Providing after-sales service, Searching for competitive products . . . etc). Having the requirement that an application is to be installed on the user's device prior to reading the tag limits the number of services that the user can reach to only the services that the user already knew about and installed before scanning the tag. Also if the product manufacturer has control over the type of services that can use the tag, this means that users might not be able to access services that retrieve information about competitive products even if these services are valuable from the user's point of view.

As mentioned earlier, to access a tag based services from a mobile phone, an application needs to be installed on the phone that is capable of reading/scanning tags, and present the user with information in the context of this tag. In a museum for example, an application that contains the logic for displaying a map of the museum and resolving the tag in the museum to locations on the map need to be installed on the user's mobile phone before scanning a tag that identifies a location. The application programming interface (API) for displaying a picture containing the map is different from one operating system to another. This means that the application displaying maps is probably platform specific, meaning that it depends on the type of the phone, and the operating system that is installed on this particular phone. As a result, a single tag based service could have multiple client applications each corresponding to a specific platform.

A better approach to tag based services is to have a single application on the user's device that is capable of scanning tags. When this application scans a tag it should present the user with a list of services that may be reached using this tag. The user can then select any of the services and start using it.

### SUMMARY

A service distribution platform, utilizes machine readable tags (codes), and makes available for use multiple services that could be reached in the context of these tags (tag based services). These services may or may not necessarily be platform dependant. That is; dependent on the combination of hardware and/or software components that are used to read the tag and interface with the user.

This presented platform allows users to access services in a streamlined workflow. A user can scan a certain tag and then get presented with a list of services that are associated with this tag. The user can then choose one of these services and start using it. Further, in at least some embodiments, a user can provide hints in the form of extra search terms or sentences to the platform along with the machine readable tags to influence the scope of the services provided by the platform.

In some embodiments, the platform allows the list of services associated with a tag to be changed by an entity other than the tag issuer.

### DISCLOSURE OF INVENTION

Although the following description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

Many of the examples in this document use a context in which service users are persons with Internet capable mobile phones that are equipped with a camera that is capable of scanning various kinds of Barcodes. It is to be appreciated and understood that the mobile phone/Barcode context is but one example and is not intended to limit the application of the claimed subject matter to only mobile phone/Barcode contexts. By way of example and not limitation, the mobile phone could be replaced by any computing device like a tablet PC, and the Barcode could be replaced by any method of accessing machine readable code like RFID, or infrared. The description below assumes some familiarity on the part of the reader with web and mobile development.

### The Platform.

FIG. 1 shows an exemplary system in accordance with one embodiment, generally at 100. Aspects of system 100 can be implemented in connection with any suitable hardware, software, firmware or combination thereof. In at least one embodiment, aspects of the system are implemented as computer-readable instructions that reside on some type of computer-readable medium.

In this example, system 100 comprises a service distribution backend 102 and a collection of service browsers 104. The service browser from the user's point of view is a single application that is installed on the device prior to accessing any tag based service. This is the application that presents the user with the list of services that are associated with a tag or a set of tags. And this is the application that launches the appropriate service client (front-end) on the user's device based on the service the user has chosen. A service browser is a platform-specific application. A platform is a combination of the software and hardware that the user uses to access tag based services.

In this example, the service distribution backend 102 comprises a publicly exposed interface 106 that service browsers 104 query for information about tags. In addition, in at least one embodiment, platform 102 contains a service info data-store 108 that stores service information. In some embodiments, platform 102 contains a service front-end store 110 housing front-ends that are specific to a certain tag based service. A front-end is an application that is specific to a certain tag based service that run on the end user's device and interpret tags in the context of the service (like displaying maps in a museum). The service front-end could be stored inside the front-end store 110, or retrieved from a location specified by the service author (like the author's website).

Further, in at least one embodiment, the service distribution backend 102 contains a service verification engine 112. This component is responsible for ensuring the integrity of the services that are attached to tags, and preventing spamming services from being attached to tags they don't belong to. In its simplest implementation this component is implemented using a review process done by humans, before actually exposing the service as attached to a tag. It is to be appreciated and understood that human filtration of services that are attached to a tag is but one example of how this task might be implemented.

The service interface 106 should be implemented in a way that is accessible from all the client service browsers 104. In one embodiment it is implemented as a web service interface. The client service browser 104 will query this web service for information about tags. For example, if the interface exposes what is called a “RESTful” endpoint, a client may issue an “HTTP GET” request to “http://www.example.com/tags/12345abc6789/services.xml” to get information about the tag with value “12345abc6789” and get a response like the one shown in FIG. 2. This response is platform independent and can be consumed by any of the client service browsers 104 that are hosted on different platforms. A client browser 104 may present this response to the user in different forms. An example of which is shown in FIG. 3, the user can click on one of the services in FIG. 3 to get more information about it and possibly launch it.

FIG. 4 shows an exemplary set of application programming interfaces (APIs) provided by the service interface 106. It is described to provide but one example of how one might implement and structure the APIs. It is to be appreciated and understood that other APIs can be utilized without departing from the spirit and scope of the claimed subject matter. The APIs are typically embodied as computer-readable instructions and data that reside on some type of computer-readable medium. The APIs are remotely accessible by the client service browsers 104 on the users' devices. The APIs in FIG. 4 are represented as a UML diagram of the interface. The UML diagram is presented only to show what are the functionalities, but not how are they exposed. The way that the functionalities are exposed is implementation specific, and it depends on the protocol used. A “RESTful” implementation may map “TagBasedService.GetServicesForTag(“12345abc6789”)” method to an HTTP GET to the URL “http://www.example.com/tags/12345abc6789/services.xml”, a “SOAP” implementation will have a different representation for this method call.

In this example, The “TagBasedService” has several attributes. Like an Identifier for the service which is typically used to identify the service object in the service info data store 108, the name of the service, the author of the service, a summary of the service functionality to be presented to the user, a URL on the web that users can go to get more information about the service, and a list of other attributes of the service which are key-value pairs of strings that may contain other attributes specific for the service (for example “Detailed Description”).

In addition, each “TagBasedService” has zero or more “ServiceFrontEnd”. The “ServiceFrontEnd” object is what stores information about how to actually make the service run on the user's device. A service in a museum that displays maps of the museum and guides visitors to their places of interest may require some sort of “customized application” (machine code) to run on the user's device. This customized application is what will retrieve the maps of the museum and information about the items on display from the museum's database. A service that gets product information or provide after-sales services for product will require a different customized application to run on the user's device. The “ServiceFrontEnd” object stores the identifier of the service it belongs to. In addition it stores the name of the platform that this “ServiceFrontEnd” applies to as “PlatformName”. A platform represents what is required so that the “customized application” referred to earlier can be presented to the user. In this context the “PlatformName” could store the name of the operating system on the user's device, or it could store a name of a virtual machine like Java virtual machine (From Sun Microsystems), or it could even be the word “web” in this case the “customized application” is a web application that is rendered on a web browser. It is to be appreciated and understood that platforms are not only limited to operating systems, web, or virtual machine. These are mentioned to provide examples of platforms not to limit them.

In addition, the “ServiceFrontEnd” object contains “PlatformConfiguration” this field stores further information about the platform itself. For example if the “PlatformName” contains a name of some operating system, then the “PlatformConfiguration” may contain the version of that particular operating system. The service browsers 104 should only launch front ends that are compatible with the configuration of the device they are running on. Further, the “ServiceFrontEnd” object has a “Hint” field which contains information about how to reach a service front end application that is to be launched on the user's device. For example, if the “PlatformName” contains a name of an operating system, the “Hint” may contain a URL of an executable file that this operating system can run. If the “PlatformName” contains the word “web” then the “Hint” will simply be the URL of the web application. In some mobile platforms, it is not allowed for applications like service browsers 104 to download and run other applications. Usually these platforms provide some sort of online store or market for applications. In this case the “Hint” will contain information about how to locate the required front end on that particular platform's online market. The service browsers 104 for these platforms should then direct the user to the location of the front end on the market based on their interpretation of the contents of the “Hint”.

In addition, the “ServiceFrontEnd” object has “Attributes” field which contains a key/value pair of information about that particular front end, it may contain information like the MIME type of the front end file if it is stored on the front-end store 110.

In addition, the “ServiceFrontEnd” has a “File” attribute which optionally contains the contents of the front end file if this particular front-end requires a file to be downloaded as it is the case with executable files. The “File” attribute is optional and normally will be used if the “Hint” is pointing to a URL that belongs to the service distribution backend 102 (i.e. stored in the front-end store 110).

Moving back to the “TagBasedService” object, it has methods for adding a new service (AddService), attaching or detaching a service from a tag or multiple tags (AttachToTag, AttachToTags, DetachFromTag, DetachFromTags), retrieving services based on a query (GetServicesForQuery), retrieving services by a single or multiple tags (GetServicesForTag, GetServicesForTags), Retrieving services by service identifier (GetService), update or delete services (UpdateService, UpdateServices, DeleteService, DeleteSerivces), and methods to add or delete “ServiceFrontEnd” (AddFrontEnd, AddFrontEnds, DeleteFrontEnd, DeleteFrontEnds).

In this example, the tags are represented as strings. This means that a method like “GetServicesForTags” could be used to retrieve services for a single/multiple tags in addition to user entered keywords (hints) to influence the scope of the returned services for example a user may provide a hint string with the value “epc” in addition to the scanned tag. In this case the “GetServicesForTags” method will get all the services that apply for the scanned tag, and also capable of handling Electronic Product Code (EPC).

In addition the “GetServicesForQuery” method is provided to allow service browsers 104 to construct complex queries based on the hints the user has provided. These are complex queries that are not easy to achieve using “GetServicesForTags”. And example input for this method could be “12345abc6789 or epc”, this query should return all the services that are directly attached to “12345abc6789” tag or “epc” tag. The “epc” tag could be used to represents all services that are capable of handling Electronic Product Code.

In addition, in at least one embodiment, calls to (AttachToTag, AttachToTags, DetachFromTag, DetachFromTags) are processed first by the service verification engine 112 before they can reflect in calls for “GetServicesForTag” or “GetServicesForTags”. The service verification engine 112 may reject a request to attach the service to a tag if it detects that this service is a spam.

FIG. 5 is a flow diagram that describes steps in a method in accordance with one embodiment. The method can be implemented in connection with any suitable hardware, software, firmware or combination thereof.

Step 500 presents a user interface allowing the user to scan tags. Any suitable user interface can be utilized. In but one embodiment, the user interface comprises a Tag Based Service browser such as the one shown in FIG. 6. It is to be appreciated and understood that the user interface can be provided in a way other than that shown in FIG. 6 without departing from the spirit and the scope of the claimed subject matter.

Step 502 presents a list of services that apply to the scanned tag. In some embodiments this step is performed by having the service browser 104 query the service distribution platform 102 for services via a call to “GetServicesForTag”, “GetServicesForTags”, or “GetServicesForQuery”. Then presenting the result to the user in a way such as the one shown in FIG. 3. It is to be appreciated and understood that FIG. 3 shows but one example of how to present the list of services to the user. Other methods of presentation could be used without departing from the spirit and scope of the claimed subject matter.

Step 504 receives a user selection for a service. This step can be performed, for example responsive to a user clicking on one of the services shown in FIG. 3. Other selection means can be utilized without departing from the spirit and scope of the claimed subject matter. Responsive to receiving the user's selection, step 506 initiates the service launch process. The service launch process varies depending on the current platform. For example, if the current platform is an operating system that requires an executable file to be downloaded and executed. The service launch process will first make sure that the front end is not already installed on the user's device, if it is not; the service distribution platform 102 is queried through the interface 106 for information about the service front end of this platform. The information about the service front end is stored in the form of “ServiceFrontEnd” object shown in FIG. 4. In case of an executable that needs to be downloaded, the “Hint” property of the “ServiceFrontEnd” object is the URL of the file to be downloaded. This URL is used to download the file then execute it to launch the service. It is to be appreciated and understood that the operating system context described but one example of how front ends are implemented, other means of implementation can be utilized without departing from the spirit and scope of the claimed subject matter. For example if the platform of the service is web, meaning that the service is provided as HTML pages that are accessible from the web, the “Hint” property is the URL of the entry point to the web application. Or if the platform does not support downloading and executing files but supports downloading applications from a custom store that is specific to this platform, the “Hint” could then point to the entry of the front end in such custom store.

### BRIEF DESCRIPTION OF DRAWINGS

FIG. 1. is a high level block diagram.

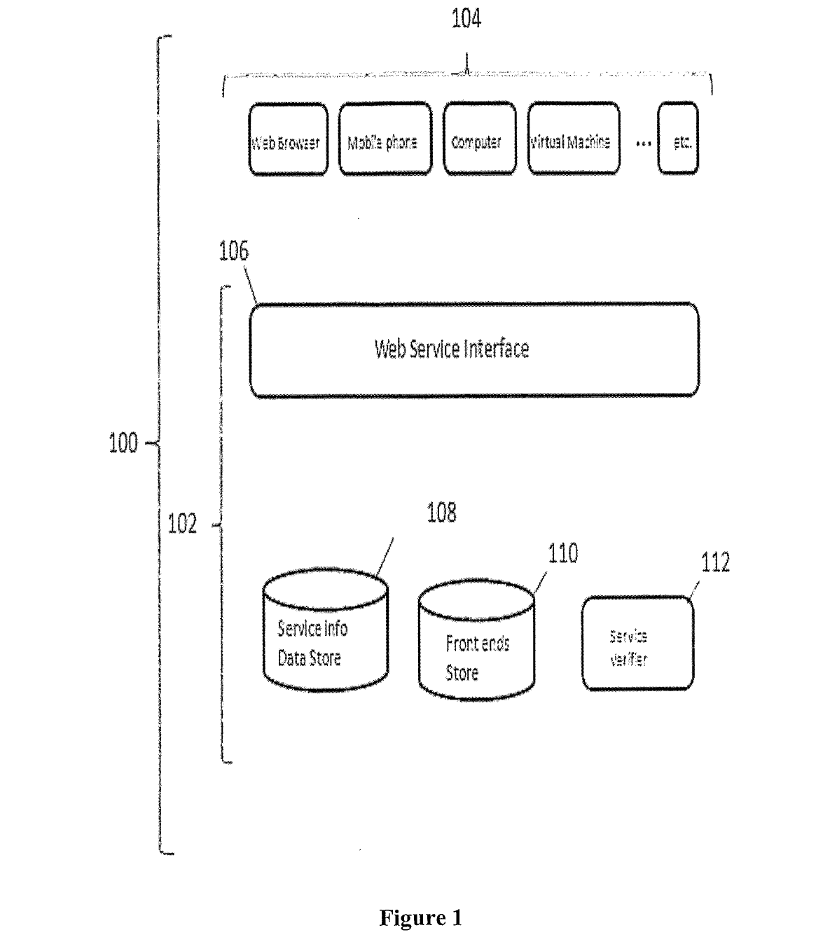

FIG. 2: illustrates an exemplary service list response in accordance with one embodiment

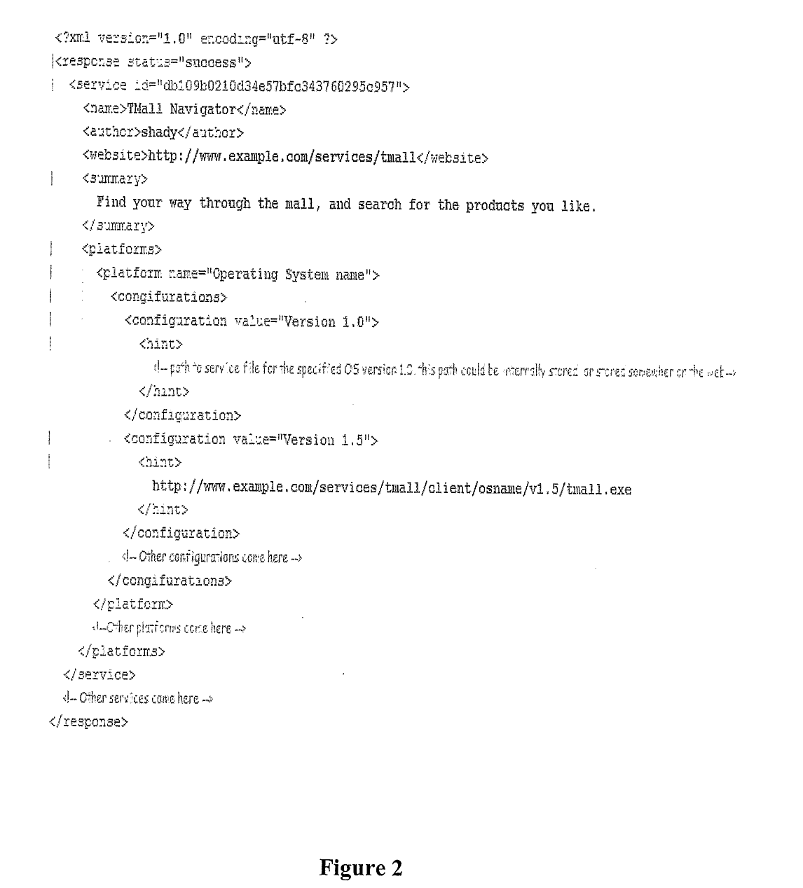

FIG. 3. illustrates an exemplary user interface displaying service list in accordance with one embodiment

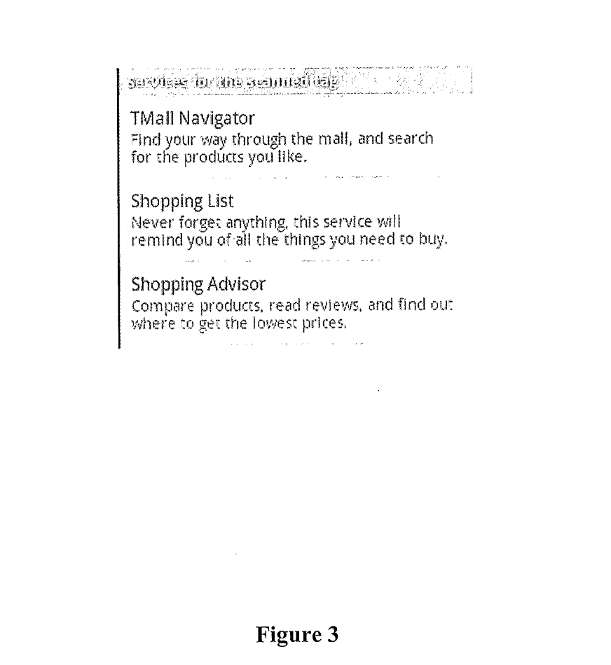

FIG. 4. illustrates an exemplary UML diagram in accordance with one embodiment

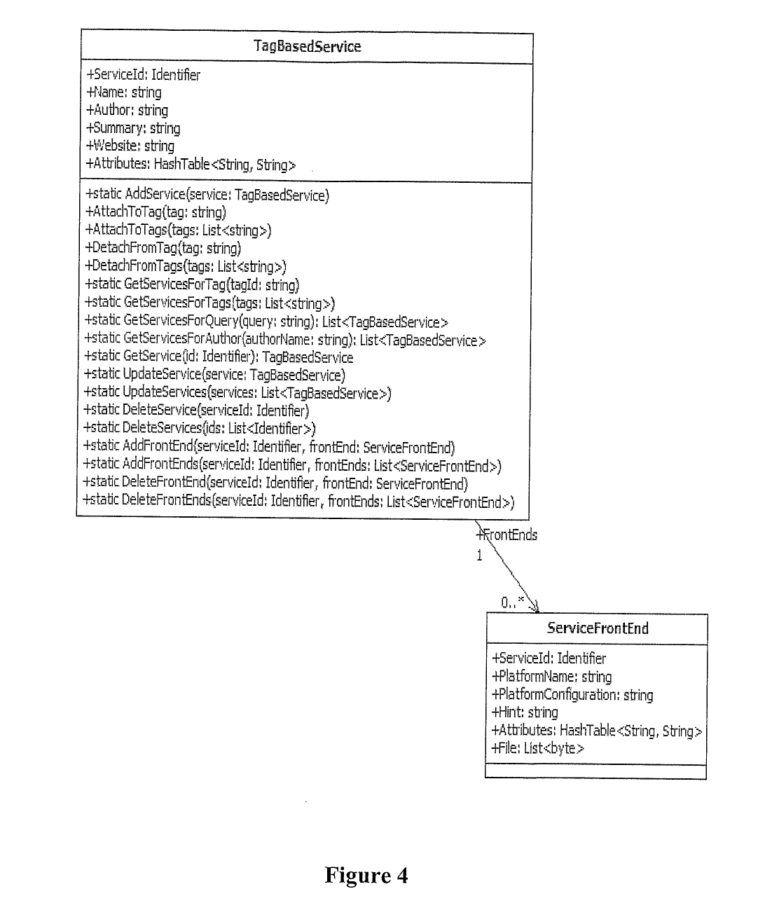

FIG. 5. a flow diagram that represents steps in a method in accordance with one embodiment

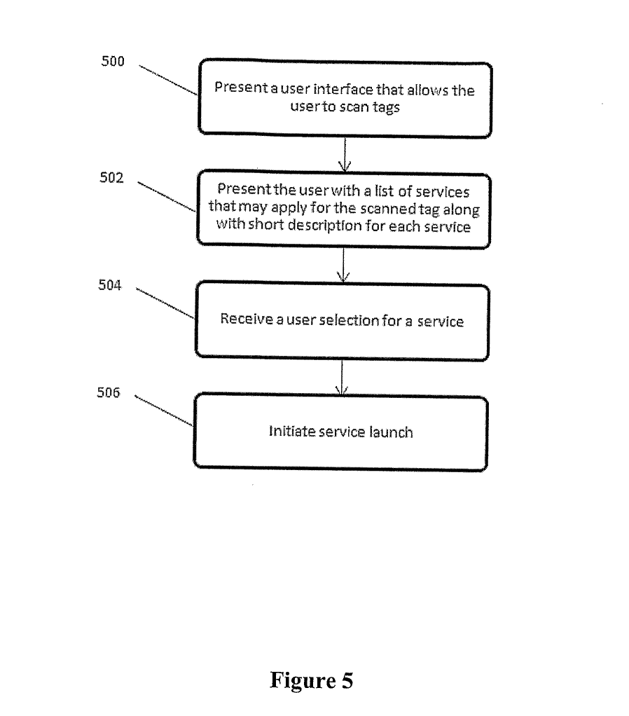

FIG. 6. illustrates an exemplary user interface in accordance with one embodiment

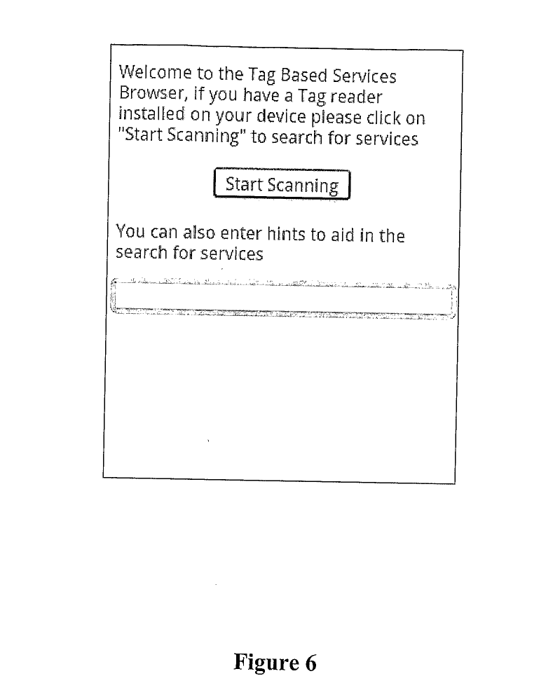

1. A computer-implemented method of providing tagging services comprising:
receiving a tag identifier from a portable computing device, wherein the tag identifier is obtained by the portable computing device from a tag;
receiving a platform identifier from the portable computing device, wherein the platform identifier identifies a computing platform of the portable computing device;
determining a plurality of services associated with the tag identifier;
determining, based on the platform identifier, a subset of services, wherein the subset of services comprises each of the plurality of services which is compatible with the computing platform of the portable computing device;
sending data describing the subset of services to the portable computing device, wherein the portable computing device is configured to present, in a user interface, a listing of the subset of services to a user of the portable computing device;
receiving, from the portable computing device, a user selection of one of the subset of services;
identifying, based on the user selection and the platform identifier, an application corresponding to the one of the subset of services, wherein the application is configured to execute on the portable computing device; and
sending an application file to the portable computing device, wherein the application file is configured to run the application on the portable computing device.

2. The method of claim 1, wherein the tag identifier is a machine readable code that is stored on the tag, and wherein the tag is a physical object.

3. (canceled)

4. (canceled)

5. The method of claim 1, wherein the computing platform is the combination of software and/or hardware that is required to scan a tag and present information to the user.

6. (canceled)

7. (canceled)

8. (canceled)

9. The method of claim 1, where in the user interface comprises a service browser interface.

10. (canceled)

11. The method of claim 1, wherein the user can submit hints to refine the subset of services.

12. (canceled)

13. (canceled)

14. (canceled)

15. The method of claim 1, further comprising:
presenting, in the user interface of the portable computing device, the listing of the subset of services to the user; and
receiving, via the user interface of the portable computing device, the user selection of one of the subset of services.

16. The method of claim 1, wherein identifying the application is further based on a user hint, wherein the user hint is received from the portable computing device.

17. The method of claim 1, further comprising:
storing the plurality of services in a service info data-store; and
providing a publicly exposed interface to the service info data-store,
wherein determining the plurality of services associated with the tag identifier comprises querying the publicly exposed interface.

18. The method of claim 17, wherein the service info data-store comprises the location of all application files corresponding to the plurality of services.

19. The method of claim 1, wherein the application comprises software for providing the one of the subset of services to the user.

20. The method of claim 1, further comprising:
adding an additional service to the plurality of services.

21. The method of claim 1, wherein the portable computing device is a mobile phone, and the tag is a barcode.

22. A system for providing tagging services, comprising:
a hardware processor;
a publicly exposed interface;
a service info data store;
a service front end store; and
a service distribution backend, executing on the hardware processor, configured to:
receive, using the publicly exposed interface, a tag identifier from a portable computing device, wherein the tag identifier is obtained by the portable computing device from a tag;
receive, using the publicly exposed interface, a platform identifier from the portable computing device, wherein the platform identifier identifies a computing platform of the portable computing device;
determine, using the service info data store, a plurality of services associated with the tag identifier;
determine, based on the platform identifier, a subset of services, wherein the subset of services comprises each of the plurality of services which is compatible with the computing platform of the portable computing device;
send data describing the subset of services to the portable computing device, wherein the portable computing device is configured to present, in a user interface, a listing of the subset of services to a user of the portable computing device;
receive, using the publicly exposed interface, a user selection of one of the subset of services from the portable computing device;
identify, based on the user selection and the platform identifier, an application corresponding to the one of the subset of services, wherein the application is configured to execute on the portable computing device; and
send an application file from the service front end store to the portable computing device, wherein the application file is configured to run the application on the portable computing device.

23. The system of claim 16, further comprising:
a service verification engine, executing on the hardware processor, configured to verify the plurality of services.

24. The system of claim 16, wherein the application file is one of a plurality of application files corresponding to the plurality of services, and wherein the plurality of application files are stored in the service front end store.
